(19) United States
(12) Patent Application Publication
(10) Pub. No.: US 2014/0135998 A1
(43) Pub. Date: May 15, 2014

(54) Method and Apparatus for Energy Efficient Heating and Air Conditioning Automation

(71) Applicants: Zhiheng CAO, Aliso Viejo, CA (US); Qingqi DOU, Aliso Viejo, CA (US)

(72) Inventors: Zhiheng CAO, Aliso Viejo, CA (US); Qingqi DOU, Aliso Viejo, CA (US)

(21) Appl. No.: 14/158,837

(22) Filed: Jan. 19, 2014

Related U.S. Application Data
(60) Provisional application No. 61/878,242, filed on Sep. 16, 2013.

(51) Int. Cl. G05D 23/19

(52) U.S. Cl. CPC G05D 23/1917
USPC 700/278

(57) ABSTRACT

A new system and associated methods are disclosed for minimize a thermostat hardware to reduce its cost, while allowing the user to regulate temperature based on information from one or more external door/window sensors, motion sensors and temperature sensors coupled indirectly to the thermostat through an Internet service. From anywhere with Internet access, the user can specify various types of algorithms to be carried out on the Internet service through a scripting language, including turning off HVAC function when a door or window sensor detects opening, turning on HVAC when a motion sensor detects motion, and controlling the thermostat based on temperature reading from the same motion sensor that last detected motion or human presence. With a prior art thermostat, user often has to press the temperature setting button multiple times until the temperature setting is raised above or lowered below current temperature to turn on heat or cooling HVAC functions. A method to allow user to turn on the HVAC functions through a single button click is also disclosed, to allow reducing the number of control elements on a thermostat.

### CROSS-REFERENCE TO RELATED APPLICATIONS

US Patent Application Publication No. 20130181839

### FEDERALLY SPONSORED RESEARCH

Not applicable

### SEQUENCE LISTING OR PROGRAM

Not applicable

### BACKGROUND OF THE INVENTION

1. Field of the Invention

This invention relates to electronics hardware and software system to allow users to automate turning on and off heating, air-conditioning and vent in a house, in multiple houses, or in multi-family residence, based on motion, temperature, humidity, infra-red, or open/closed information gathered by wireless sensor tags connected to the same system.

2. Description of the Related Art

N/A

### BRIEF SUMMARY OF THE INVENTION

The present invention provides a method and an apparatus for giving notifications such as sound, ring-tone, vibration, e-mails, text messages, or phone calls to user when window/door/gate is opened or closed, when human presence is detected, or when temperature or humidity has exceeded or returned within a range. Notifications may also be given when communication link is disrupted or re-established. At the same time, it allows users to specify custom algorithms that automatically turn on or off heat or air-conditioning based on the window/door/gate open/closed status, human presence status, communication link status, or temperature/humidity status, in order to optimize energy usage and improve user comfort.

An embodiment of the present invention comprises a central wireless unit connected to the Internet, referred hereafter as “tag manager”; multiple battery powered wireless units with integrated sensors, referred hereafter as “sensor tags”, one or more wireless units with electronic relays, referred hereafter as “thermostat”, and one or more servers connected to the Internet, referred hereafter as “Web Server” or “Chat Server”. Each sensor tag includes necessary means, such as elastic band, Velcro tapes, key-rings, screws, or glues for mounting to various items or animals. The tag manager communicates with Internet servers to upload events received from each sensor tags and receive commands issued by the user and transmit wirelessly to applicable sensor tags and thermostats.

The present invention provides a method and an apparatus to reduce the power consumption of each sensor tag and thermostat such that they can be powered by a single coin cell battery without need of replacement for a year or more.

Each sensor tag in an embodiment includes a battery, a radio frequency (RF) transceiver, a microcontroller, flash memory, a temperature sensor, optionally a relative humidity (RH) sensor, optionally Hall effect/reed sensor, optionally 3-axis digital magnetic sensor, optionally passive infra-red sensor, and optionally one or more audible signal generator such as a piezo buzzer. Each thermostat in an embodiment includes a RF transceiver, a microcontroller, flash memory, multiple solid state relays, buttons for manual control, indicator lights to provide visual indication and feedback, and optionally temperature and RH sensor.

The microcontroller and/or RF transceiver include power saving circuitry and control methods to reduce the power consumption needed to maintain communication link with the tag manager. The control methods allow reporting remaining battery life (which may be detected by current battery voltage) back to the tag manager. This provides centralized monitoring of multiple sensor tags and thermostats and identification of those sensor tags or thermostats requiring maintenance.

### BRIEF DESCRIPTION OF THE SEVERAL VIEWS OF THE DRAWING

The invention can be better understood with reference to the following detailed description together with the appended drawings in which like elements are numbered the same:

FIG. 1 depicts a functional view of a preferred embodiment of the present invention;

FIG. 2 depicts a functional view of a preferred embodiment of a contact based open/close sensor tag of the present invention;

FIG. 3 depicts a functional view of a preferred embodiment of a passive infra-red (PIR) sensor tag of the present invention;

FIG. 4 depicts a functional view of a preferred embodiment of a thermostat of the present invention;

FIG. 5 depicts a functional view of a preferred embodiment of a tag manager of the present invention;

FIG. 6 depicts a preferred steady state control flow chart used by the embodiment of a tag manager shown in FIG. 5;

FIG. 7 depicts a preferred control flow chart used by the embodiment of a thermostat or a sensor tag shown in FIG. 2, FIG. 3, and FIG. 4;

FIG. 8 depicts a timing diagram of the present invention during a wireless communication between a tag manager and multiple sensor tags or thermostats;

FIG. 9 depicts a preferred control flow chart used by the embodiment of a sensor tag shown in FIG. 2 and FIG. 3;

FIG. 10 shows a table illustrating examples of custom algorithms and the way each one can be specified;

FIG. 11 depicts a preferred control flow chart used by the embodiment of a tag manager shown in FIG. 5, illustrating in more detail the initial start-up sequence and the interaction among the tag manager, the Web Server and the Chat Server;

FIG. 12 shows a table illustrating operation performed by the Web Server; and

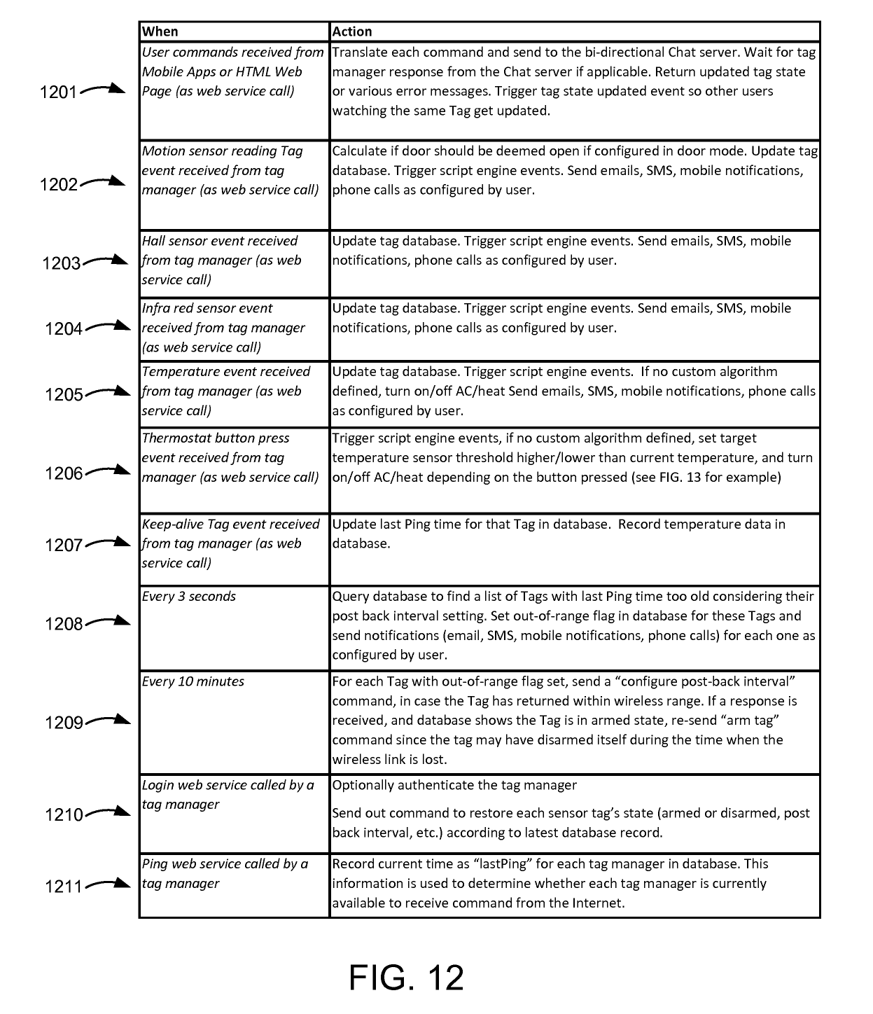

FIG. 13 illustrates a preferred function of each physical button on the Thermostat in FIG. 4.

### DETAILED DESCRIPTION OF THE INVENTION

Construction

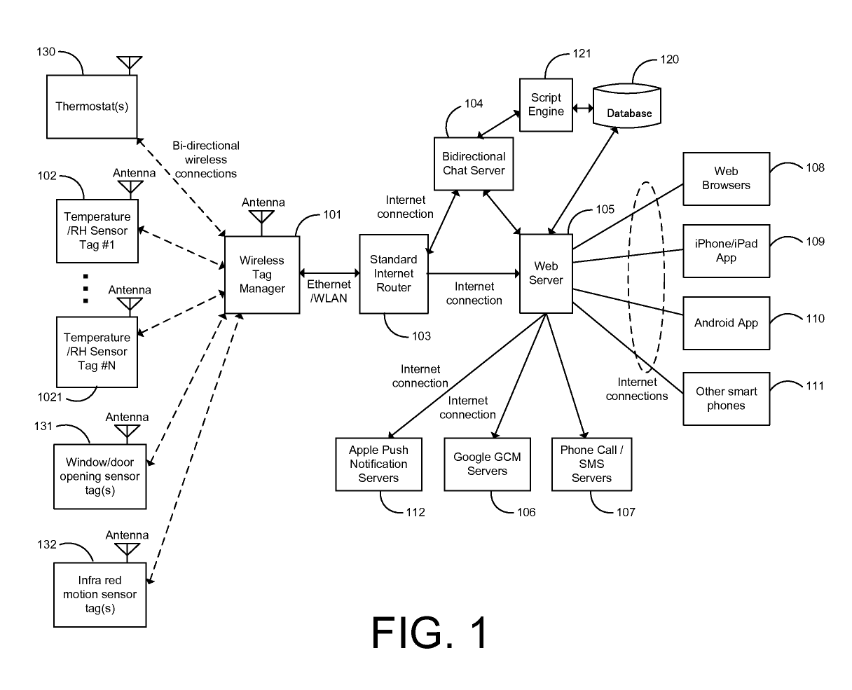

FIG. 1 shows a system-level block diagram of a preferred embodiment of the present invention including multiple sensor tags 102, 1021, 131, 132, a thermostat 130, a tag manager 101, and an Internet router 103, which preferably is a standard, general purpose router such as Linksys E1000. 101, 1021, 130, 131, 132 and 103 typically reside in customer premise such as a house, a store, an office building, or a multi-family residence. The router 103 is connected through the Internet to one or more bi-directional Chat Servers 104, preferably running a standard based IRC (Internet Relay Chat) Chat Server program. 105 represents one or more Web server(s), preferably running a standard based HTTP server such as Microsoft IIS (Internet Information Server), which are also connected through internet to router 103. Servers 104 and 105 may reside on the same computers or on separate computers that are connected through the Internet. In place of a Chat Server 104, other means to achieve bi-directional communication between the tag manager 101 and Web Server 105 may also be used. For example, a Web Socket, or a “long-poll” technique may be used for the tag manager to receive commands from the Web Server 105, instead of through a Chat Server 104 as chat messages sent by Web Server 105. If these techniques are used, Chat Server 104 is not necessary.

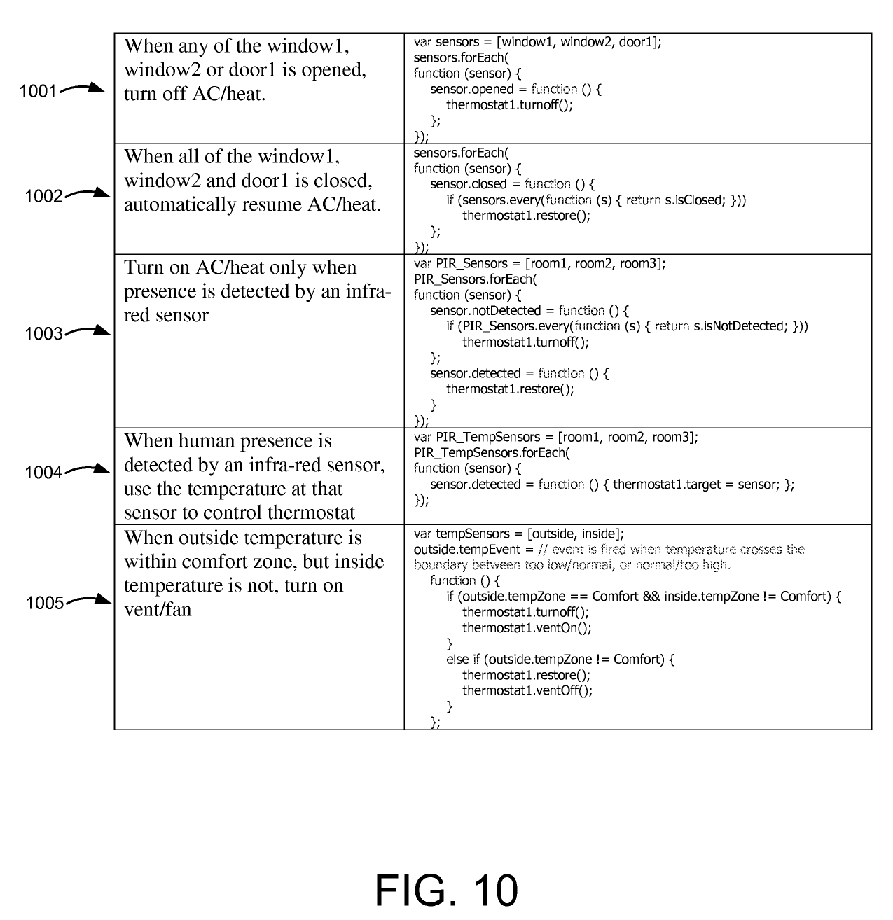

A relational database 120, preferably implemented using Microsoft SQL Server 2008, is available for access from each of the Web Server 105 and Script Engine 121. Script Engine 121 preferably runs as a separate process with limited access rights, and retrieves user configured custom algorithms, preferably written in JavaScript, from database 120. Script Engine 121 is preferably implemented by using JavaScript parser libraries such as JURASSIC. Script Engine 121 registers for change notifications on certain fields of the database 120 depending on user algorithm to trigger even handlers in the user algorithm, such as when window is opened, closed, motion detected, motion not detected for certain timeout period, or temperature sensor reading crossing upper or lower thresholds. For example refer to FIG. 10. Script Engine exposes methods callable from user algorithms that eventually issues command to the user's Tag Manager 101 through Chat Server 104.

Client devices such as web browsers 108, iPhone or iPad devices running custom App 109, Android devices running a custom App 110, or other types of smart phones 111 need only be able to access web services provided by Web Server 105 through the Internet.

Web Server 105 may optionally connect through internet to an Apple Push Notification Server 112 to send notification messages to iPhone or iPad Apps 109, to a Google GCM (Google Could Messaging) server 106 to send messages to Android devices 110, or to various types of servers 107 designed to make phone calls or send text messages.

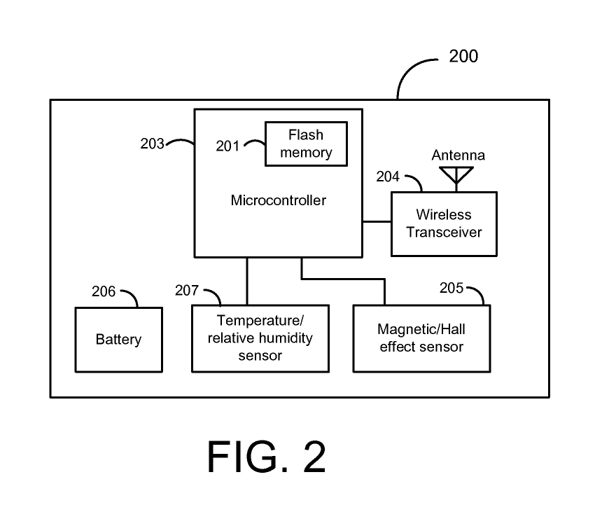

Now referring to FIG. 2, which shows a preferred embodiment of a window/door opening sensor tag 200, appearing also as 131 in FIG. 1. A control circuit 203 is preferably implemented using widely available general purpose microcontroller integrated circuits (IC) such as part number PIC16LF721 from Microchip. The control circuit 203 preferably includes a flash memory device 201 to store identification (ID) information unique to each sensor tag, and control flows disclosed in the present invention in the form of a firmware program. Other types of microcontroller IC may also be used for control circuit 203 and ID information can be stored using jumper switches or stored in Random Access Memory (RAM) found in most microcontroller ICs.

A wireless transceiver 204 is preferably implemented by using a 433 MHz band RF transmitter IC typically found in garage openers such as part number MRF47XA from Microchip or AX5043 from AXSEM, together with conventional necessary external components such as a crystal, a power supply, capacitors (not shown in figure). The transceiver 204 is coupled to control circuit 203 on a printed circuit board preferably using a serial communication standard such as SPI or I2C. Alternatively control circuit 203 and transceiver 204 may be combined inside a single chip such as part number Si1020 also from Silicon Laboratories.

A magnetic sensor 205, preferably be low power Hall Effect switch part number SL353LT from Honeywell, or 3-axis or 3D digital compass IC part number HMC5883L from Honeywell, is coupled to control circuit 203. If 3D digital compass is used, preferably the power supply of sensor 205 is also connected to an I/O pin of control circuit 203. This allows control circuit 203 to turn on sensor 205 periodically for a short amount of time to take a measurement of 3D vector of the magnetic field of the Earth with respect to the orientation of the sensor tag 200 on which the sensor 205 is permanently attached. This also allows control circuit 203 to completely turn off sensor 205 for the majority of the time to achieve low average power consumption. By recording this field vector at user specified interval, any slight orientation change resulted from the sensor tag 200 being touched/moved can be detected, while consuming very little power. When the Hall Effect switch is used, the sensor tag 200 is installed together with a magnet piece, when contact/separation between 200 and the magnet piece happens because of window close/open events, the Hall Effect switch wakes the control circuit 203 up from sleep.

A battery 206, preferably CR2450 that balances dimensions, cost and capacity resides inside sensor tag 200 and may be used to power circuits on sensor tag 200. A temperature sensor 207 which preferably also includes relative humidity measurement capability, preferably be part number HTU21D from Measurement Specialties Inc, is coupled to control circuit 203 through serial communication such as I2C or SPI. Control circuit 203 periodically enables 207 to take measurement of local temperature and/or humidity at the door/window sensor tag 200.

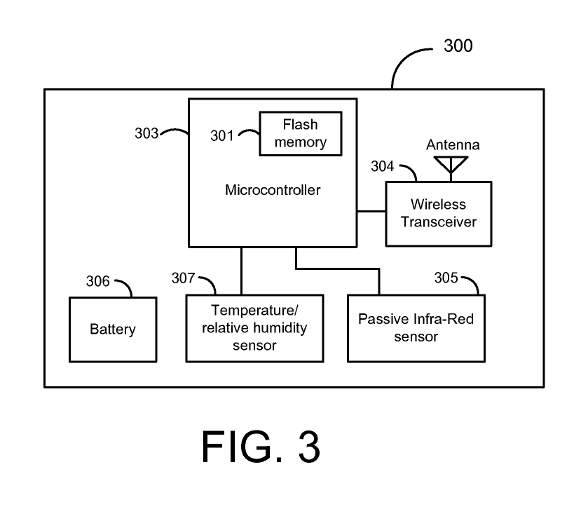

Now referring to FIG. 3, which shows a preferred embodiment of an infra-red motion sensor tag 300, appearing also as 132 in FIG. 1. A control circuit 303 is preferably implemented using widely available general purpose microcontroller integrated circuits (IC) such as part number PIC16LF721 from Microchip. The control circuit 303 preferably includes a flash memory device 301 to store identification (ID) information unique to each sensor tag, and control flows disclosed in the present invention in the form of a firmware program.

A wireless transceiver 304 is preferably implemented by using a 433 MHz band RF transmitter IC typically found in garage openers such as part number MRF47XA from Microchip or AX5043 from AXSEM, together with conventional necessary external components such as a crystal, a power supply, capacitors (not shown in figure). The transceiver 304 is coupled to control circuit 303 on a printed circuit board preferably using a serial communication standard such as SPI or I2C. Alternatively control circuit 303 and transceiver 304 may be combined inside a single chip such as part number Si1020 also from Silicon Laboratories.

A passive infra-red sensor 305, preferably be part number EKMB1303111 from Panasonic is coupled to control circuit 303. When motion is detected, the infra-red sensor 305 wakes the microcontroller 303 up from sleep. A battery 306, preferably CR2450 that balances dimensions, cost and capacity resides inside sensor tag 300 and may be used to power circuits on sensor tag 300. A temperature sensor 307 which preferably also includes relative humidity measurement capability, preferably be part number HTU21D from Measurement Specialties Inc, is coupled to control circuit 303 through serial communication such as I2C or SPI. Control circuit 303 periodically enables 307 to take measurement of local temperature and/or humidity at the infra-red sensor tag 300.

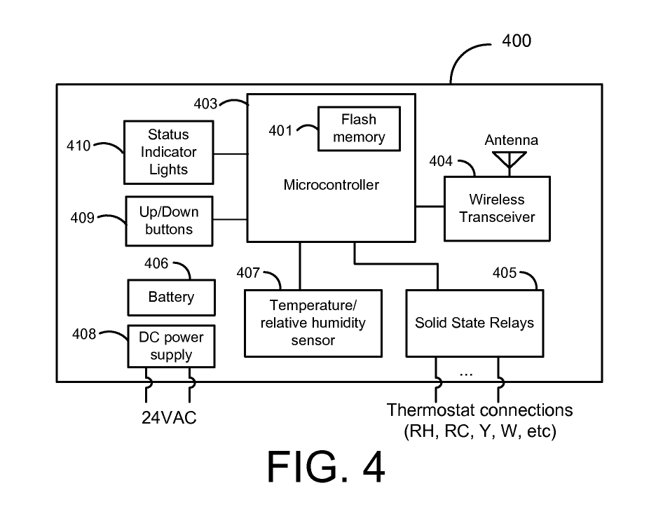

Now referring to FIG. 4, which shows a preferred embodiment of a thermostat 400, appearing also as 130 in FIG. 1. A control circuit 403 is preferably implemented using widely available general purpose microcontroller integrated circuits (IC) such as part number PIC16LF721 from Microchip. The control circuit 403 preferably includes a flash memory device 401 to store identification (ID) information unique to each thermostat and sensor tag, and control flows disclosed in the present invention in the form of a firmware program.

A wireless transceiver 404 is preferably implemented by using a 433 MHz band RF transmitter IC typically found in garage openers such as part number MRF47XA from Microchip or AX5043 from AXSEM, together with conventional necessary external components such as a crystal, a power supply, capacitors (not shown in figure). The transceiver 404 is coupled to control circuit 403 on a printed circuit board preferably using a serial communication standard such as SPI or I2C. Alternatively control circuit 403 and transceiver 404 may be combined inside a single chip such as part number Si1020 also from Silicon Laboratories.

Electronic switches 405 preferably be Solid State Relays part number CPC1006N from IXYS, is coupled to control circuit 403, allowing the control program running on 403 to open or close the switches which are connected to thermostat connections. This allows 403 to turn on/off heat, air-conditioning and/or fan or vent.

A battery 406, preferably CR2450 that balances dimensions, cost and capacity resides inside thermostat 400 and may be used to power circuits on thermostat 400. A temperature sensor 407 which preferably also includes relative humidity measurement capability, preferably be part number HTU21D from Measurement Specialties Inc, is coupled to control circuit 403 through serial communication such as I2C or SPI. Control circuit 403 periodically enables 407 to take measurement of local temperature and/or humidity at the thermostat 400.

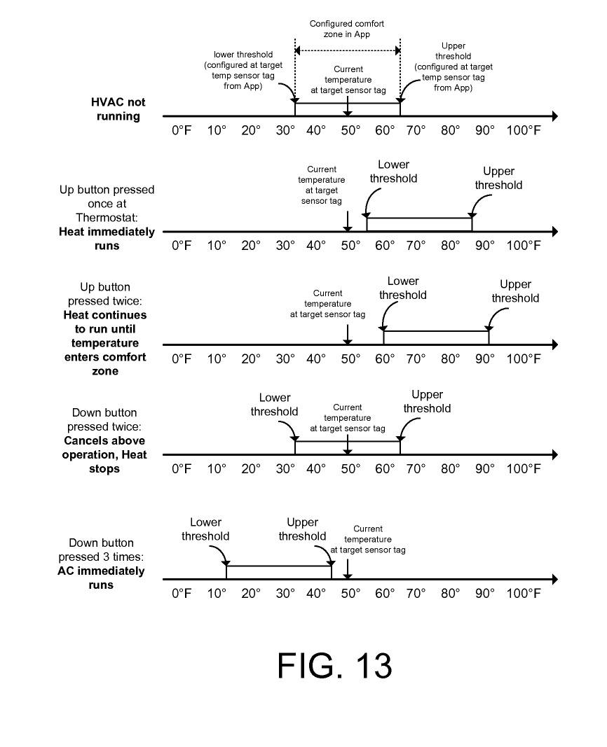

A DC power supply 408, preferably comprising capacitors, a diode and a Zener diode, resides inside thermostat 400 and may be connected to external 24 VAC power. The DC power supply 408 preferably generates 3.3 VDC from the external power to power circuits on thermostat 400. Up/down buttons 409 is coupled to control circuit 403 to allow users to turn on/off heat or AC locally with a single click, with or without wireless access to the Tag Manager 101 or Web server 105. FIG. 13 illustrates a preferred function of each button. Buttons 409 may be disabled centrally by settings from administrative user through command from Chat server 104. Indicator lights 410 are coupled to control circuit 403 to provide visual feedback when buttons 409 are pressed, and when AC or heat is turned on or off by command from Chat server 104.

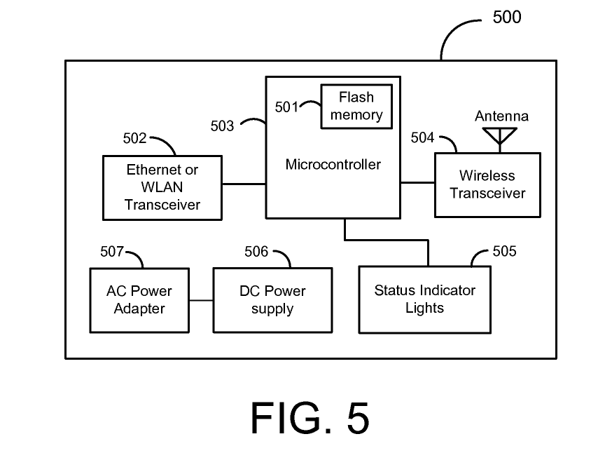

Now referring to FIG. 5, which shows a preferred embodiment of a tag manager 500. A control circuit 503 is preferably implemented using widely available general purpose microcontroller integrated circuits (IC). The control circuit 503 preferably includes a flash memory device 501 to store a serial number unique to each tag manager, Internet address of the Web Server 105, and control flows disclosed in the present invention in the form of a firmware program. An Ethernet transceiver 502, such as part number ENC28J60, is coupled to control circuit 503. Transceiver 502 and control circuit 503 may be integrated into a same IC, such as part number PIC18F67J60 from Microchip. Alternatively, a wireless-LAN transceiver may be used in place of Ethernet transceiver 502. A wireless transceiver 504 is preferably implemented by using a 433 MHz band RF transmitter IC such as part number MRF47XA from Microchip or AX5043 from AXSEM, together with conventional necessary external components such as a crystal, a power supply, capacitors (not shown in figure). The transceiver 504 is coupled to control circuit 503 on a printed circuit board preferably using a serial communication standard such as SPI or I2C. Control circuit 503 is further coupled with status indicator lights 505, preferably implemented as one or more of light emitting diodes (LEDs). The tag manager 500 is preferably powered by an external power source, such as wall plug or a USB cable. A DC power supply 506 may be included in the tag manager to supply power to electronic components inside the tag manager 500 and an AC power adapter 507 may be used to convert wall plug AC down to DC voltage needed by 506.

### Operation

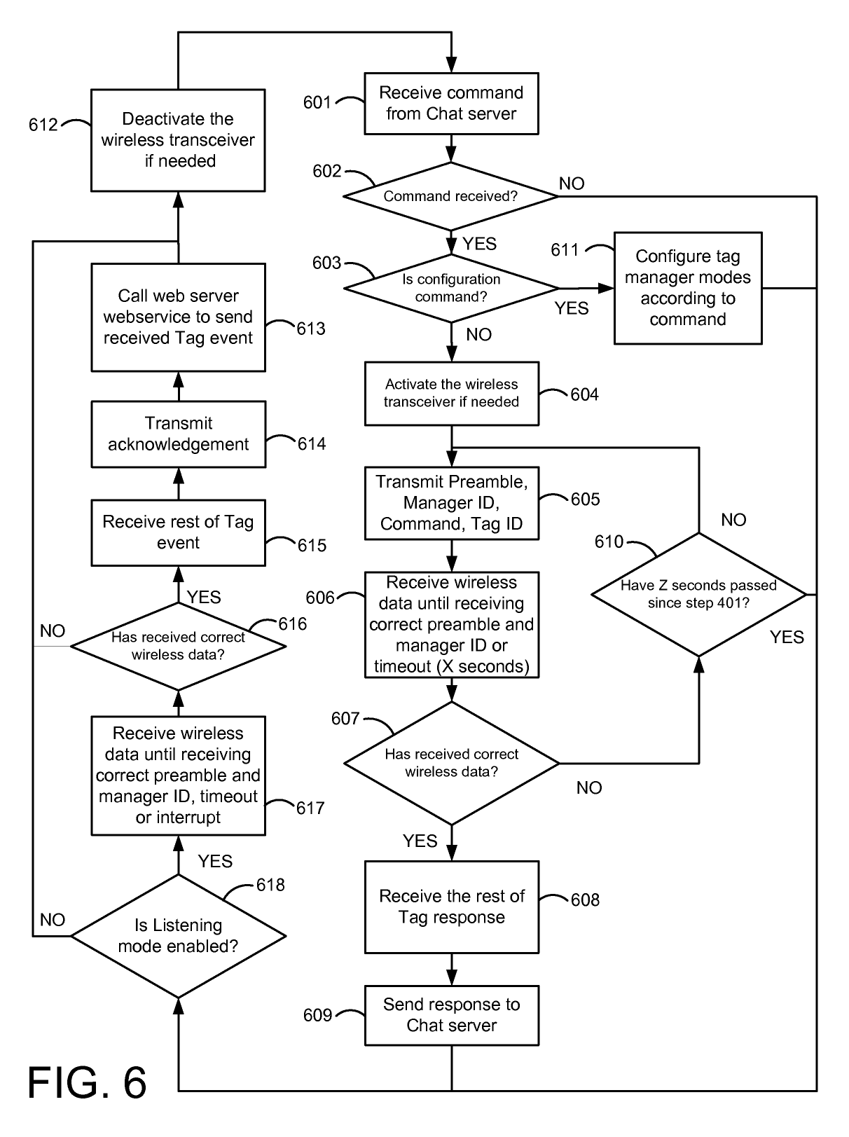

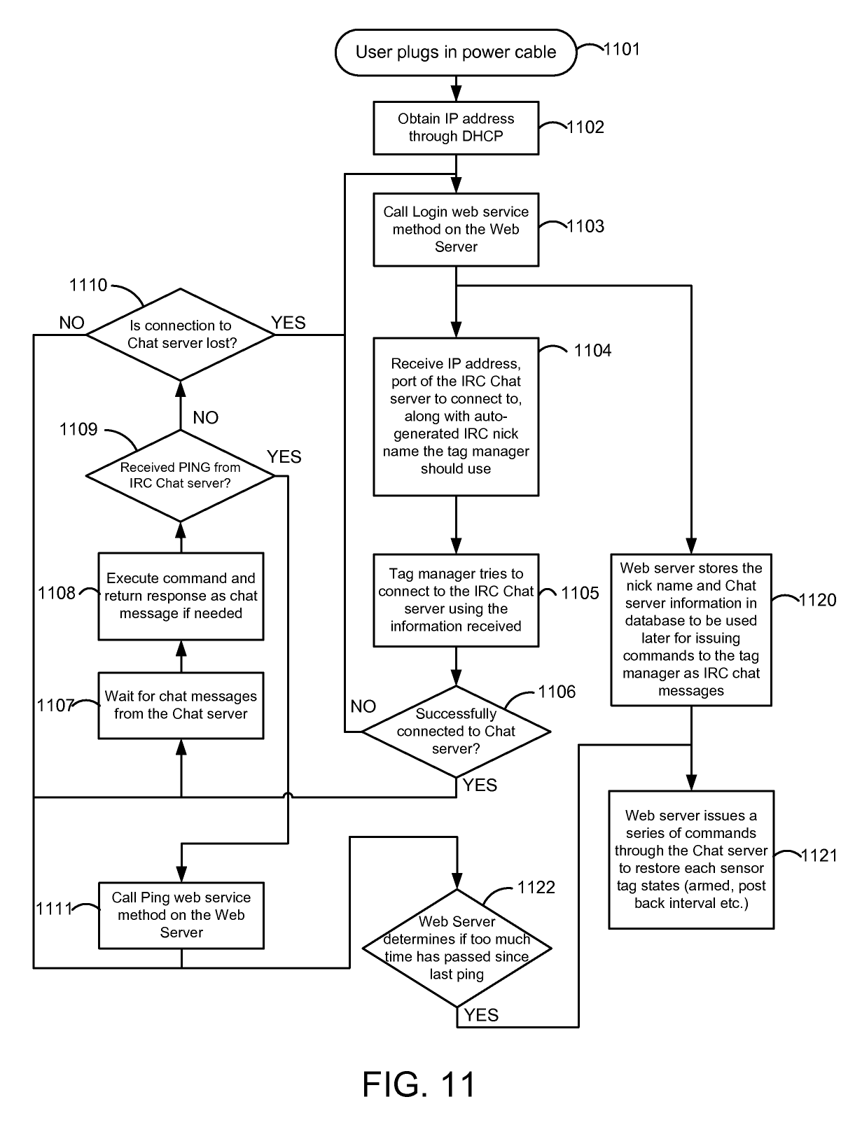

FIG. 6 depicts a preferred control flow chart used by the embodiment of a tag manager shown in FIG. 5, in a steady state loop, after an initial start-up sequence. The start-up sequence is described later in association with FIG. 11. This control flow can be implemented as a firmware program, a software program, or as digital hardware using finite state machine. In step 601, the control circuit 503 tries to receive a command from the Chat Server 104 in the form of a chat message sent by Web Server 105. If the command is received in step 602, in step 603 the command is decoded and checked if it is a configuration command or a command requiring wireless transmission. If the command is not received, steps 603 to 609 are skipped immediately and step 617 is executed if in “Listening mode”. This ensures that when not executing any command, tag manager will for the majority of the time be in a state ready to receive events from each sensor tag 102. If a configuration command is received, the tag manager updates its internal states (for example, setting “Listening mode” flag.) If received command is not a configuration command but rather a command targeting one or multiple sensor tags, in step 604 wireless transceiver 504 is activated as needed, and in step 605, a sequence of data comprising a preamble, a tag manager ID, a command ID, and target sensor tag ID is transmitted by transceiver 504. Immediately in the following step 606, transceiver 504 switches to receive mode and tries to receive a response for a short period of time (X seconds). The timeout value X should be chosen just enough to receive a preamble and a tag manager ID. This allows the tag manager to repeat transmission in step 605 as frequently as possible, and hence to increase the chance the transmission be received by a sensor tag. If in the following step 607, the beginning of a correct sensor tag response comprising a correct preamble and a matching tag manager ID is not received, steps 605 and 606 are repeated until Z second (user configured command timeout) has passed, which is checked in step 610. If in step 607 the beginning of a correct sensor tag response is received, remaining part of the tag response is received in step 608. In the following step 609, the tag response is translated to a chat message to be received by Web server 105.

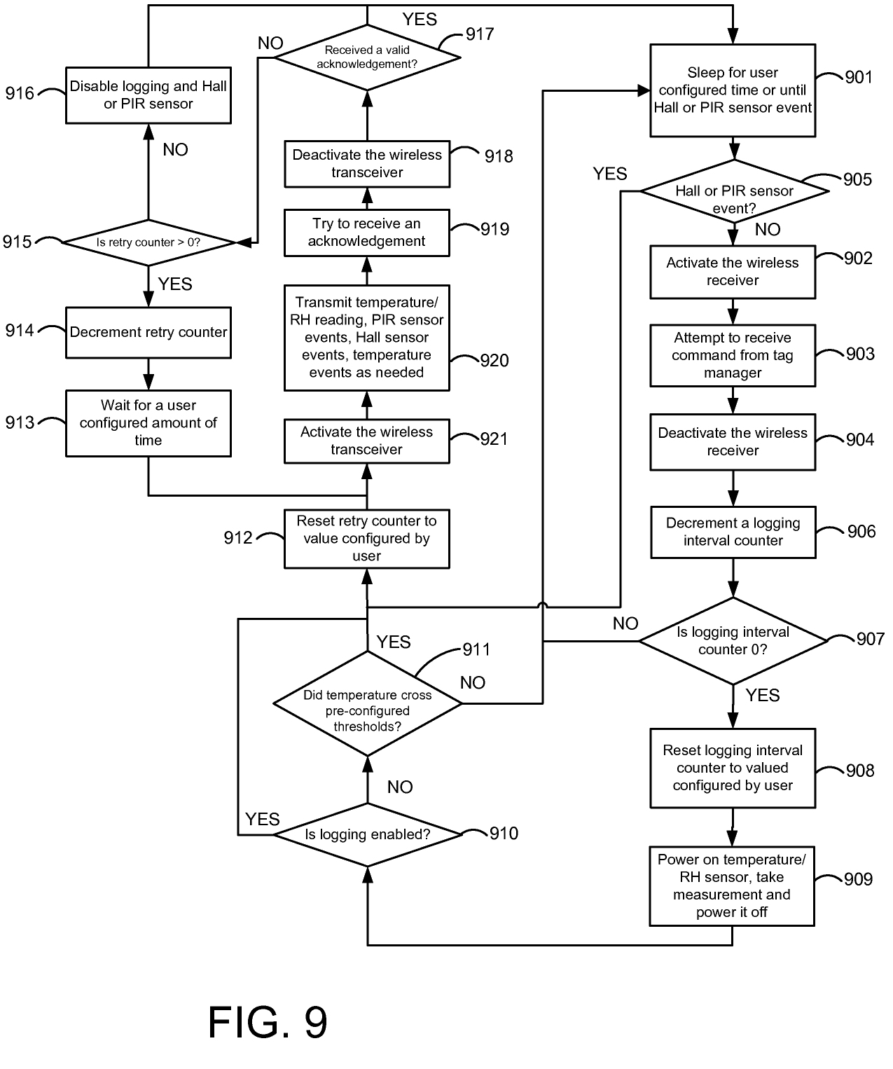

In step 618, if the tag manager is not configured to “Listening mode”, for example when none of the sensor tag is armed, then the control circuit transitions to step 612 to turn off transceiver if needed and starts receiving the next command in step 601. This maximizes responsiveness of the tag manager to any user command issued to the Web Server 105, which translate the command and send to the Chat Server 104. If the tag manager is configured to “Listening mode”, in step 617 the tag manager will try to receive any wireless messages from a sensor tag by putting the transceiver 504 in receive mode. In a simple embodiment, a timeout value may be chosen for example at 0.5 second, such that there is a maximum 0.5 second delay in responding to user command, but long enough time to ensure that for the majority of time the tag manager is ready to receive any sensor tag transmission of events. Even when any sensor tag transmit at a time when the tag manager happens to be not receiving, automatic re-transmission described later in association with FIG. 9, allows reliable transmission of sensor tag events to the tag manager. Alternatively, in a more sophisticated embodiment, receive step 617 may continue for a longer period of time, but be terminated by a Receive Packet Pending Interrupt (or equivalent interrupt) from the Ethernet/WLAN transceiver 502, such that the tag manager can immediately respond to any incoming command from the Internet.

In step 616, if a correct preamble and matching tag manager ID is found in messages received in step 617, the remaining part of the wireless packet is received in step 615. If timeout or an Ethernet/WLAN interrupt occurs, steps 613 to 615 are skipped. In step 614, the tag manager immediately transmits an acknowledgement wireless message using wireless transceiver 504. In the following step 613, received data in steps 615 and 617 are sent to Web server 105 preferably in the form of a web service call. In step 612 the transceiver 504 is powered off if not in Listening mode, or already powered off.

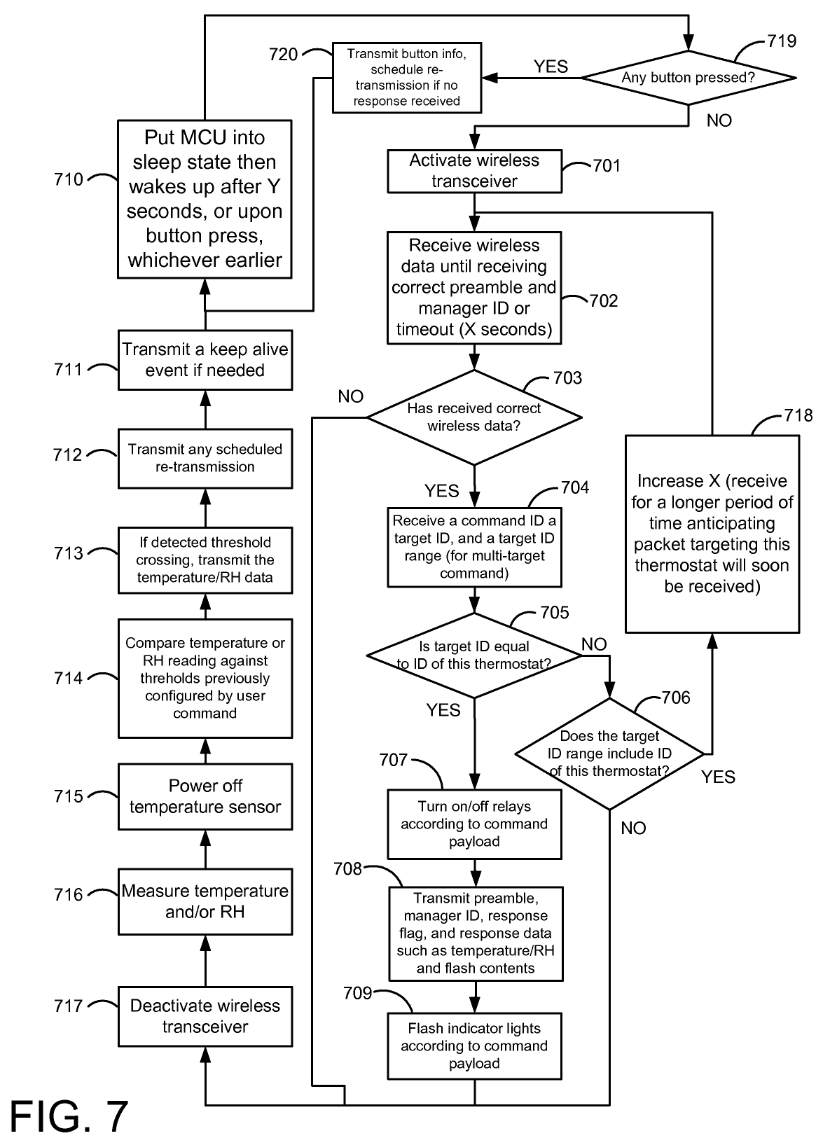

FIG. 7 depicts a control flow used by the embodiment of a thermostat, or a sensor tag shown in FIG. 4, FIG. 2 and FIG. 3, in a steady state loop after powering up and a conventional initialization sequence. This control flow can be implemented as a firmware program or as digital hardware using a finite state machine. In step 701, the control circuit 203, 303 or 403 wakes up from sleep and activates the transceiver 204, 304 or 404 and put it in receive mode. In step 702, the thermostat or sensor tag tries to receive a response for a short period of time (X seconds). The timeout value X is chosen by experiment considering the trade-off between average battery power consumption in idle and the likelihood it can catch a wireless command transmitted by the tag manager. If in the following step 703 the beginning of a correct tag manager command comprising a correct preamble and a matching tag manager ID is not received, in step 717 the transceiver 204, 304 or 404 is deactivated to conserve power. If in step 703 the beginning of a correct tag manager command is received, remaining part of the tag manager command, comprising a command ID, a flag indicating if the command ID is a multiple target command, a target sensor tag ID, and optionally for multiple target command, target ID range information (minimum and maximum sensor tag ID to be targeted), is received in step 704. In the following step 705, the control circuit 203, 303 or 403 compares the received target sensor tag ID against ID of the present thermostat or sensor tag which may be stored in flash memory 201, 301 or 401. If they are equal, the received command is carried out in step 707. Otherwise, if the command is multiple target command, in step 706, the control circuit 203, 303 or 403 determines if the ID of the present sensor tag is within the received target ID range. If yes, in step 709 the timeout value X is increased, in order to receive for a longer period of time in step 702 anticipating packet targeting this tag will soon be received, and the control flow transitions to step 702. If the command is not multiple target command or target ID range does not include ID of the present tag or thermostat, then in step 717 the transceiver 204, 304 or 404 is deactivated to conserve power.

After carrying out non-time-consuming commands in step 707, or scheduling to execute the command later if the command is time consuming such as Flash memory write, in step 708 the thermostat or sensor tag transmits using wireless transceiver 204, 304 or 404 a response comprising the preamble, a tag manager ID, a response flag, and response data such as battery voltage or flash memory contents, then powers off transceiver 204, 304 or 404 in step 717.

In the steady state loop of the sensor tag, the thermostat or sensor tag 200, 300 or 400 may be configured to carry out a series of actions in steps 711 to 716. These steps 711 to 716 may be executed once every N (a configurable positive integer) times the control flow passes them, thereby allowing user to configure the frequency at which these actions are executed, in order to achieve an optimum trade-off between average power consumption of the sensor tag (hence battery life) and timeliness of results. In step 716, control circuit 403 may power on the temperature/RH sensor 207, 307 or 407 and take measurement of local temperature and relative humidity. The sensor 205, 305 or 405 is immediately powered off after measurement in step 715 to conserve power. In step 714, if a new measurement shows the temperature or humidity has crossed the upper or lower threshold set by the user, the new measurement data are transmitted using transceiver 204, 304 or 404 to the tag manager as a temperature or humidity event in step 713. If no acknowledgement response is received from tag manager, re-transmission is scheduled. If logging is enabled, the measured temperature and/or humidity data may be transmitted to tag manager periodically in step 711. The detail of this step is discussed later in association with FIG. 9.

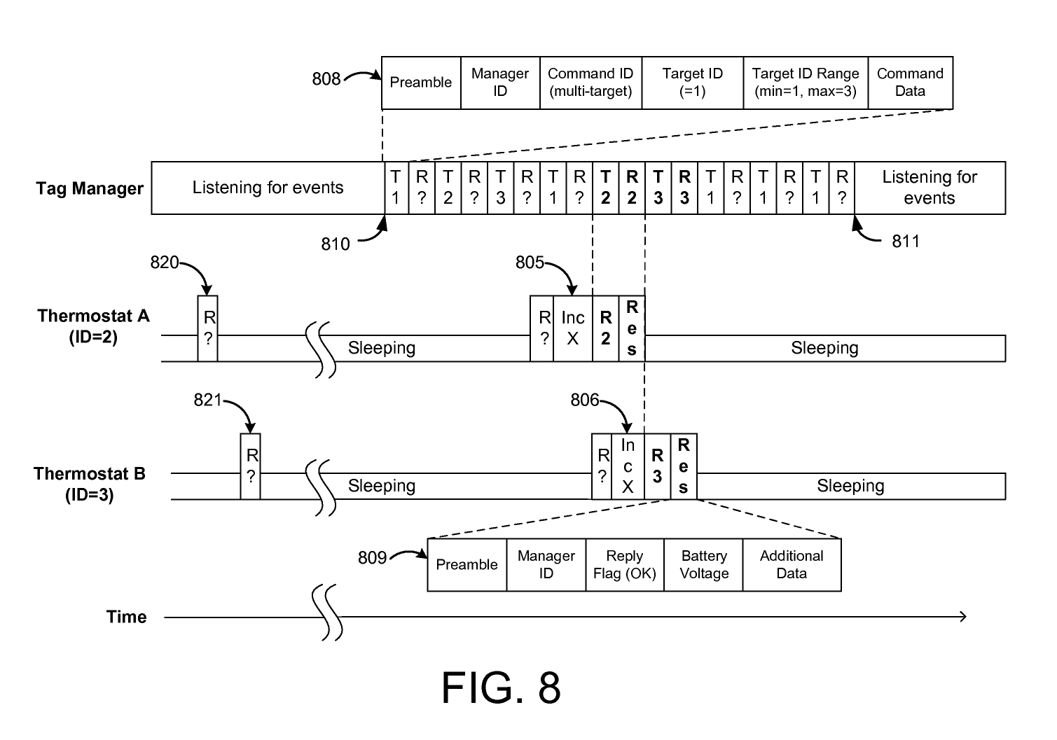

In step 712, transmissions done in step 713 or step 720 that did not receive acknowledgement response from the tag manager and have been scheduled for re-transmission are re-transmitted. In step 711, at user configured interval, the sensor tag transmits a keep-alive “ping” using transceiver 204, 304 or 404 to the tag manager. This allows software running in Web server 105 to monitor if each sensor tag is alive or out-of-range. The detail of this step is disclosed in FIG. 8 of US Patent Application Publication No. 20130181839. In step 710 the control circuit 203, 303 or 403 is put in a sleep state until a configurable timeout happens, or any button press if the thermostat or sensor tag has physical buttons, whichever is earlier. In step 719 if any button is pressed, in step 720 the information about which button(s) are pressed is transmitted to the tag manager, if no acknowledgement response is received from tag manager, re-transmission is scheduled. If re-transmission fails for pre-configured number of times, the thermostat 400 may enter a manual mode and directly turn on/off heat/AC using relays 405 based on user button presses and the latest measurement data from temperature/RH sensor 407, without involving the tag manager. The details about how the up or down button press can preferably control heat or AC is shown in FIG. 13.

Now referring to FIG. 8, which shows a timing diagram of the present invention during a wireless communication between a tag manager and multiple thermostats or sensor tags, before, during and after the tag manager transmits a multiple-target command targeting thermostat or sensor tags with ID of 1, 2, and 3. Only thermostats with ID of 2 and 3 are currently within range. The horizontal axis is time (not to scale), and the height of each block represents relative instantaneous power consumption. Before the instant 810, the tag manager is mostly in step 617. Blocks “R?” represent step 606 or 702, where no correct preamble and manager ID has been received before timeout. During activities 820 and 821, which last for approximately X seconds, each sensor tag consumes relatively high instantaneous power, but since this happens every Y seconds when no command is issued by the tag manager (idle state), average power consumption is reduced to approximately X/(Y+X) times (assuming during sleep power consumption is negligible). X is much smaller than Y, and since Y can be configured by user to be arbitrarily large, average sensor tag power consumption during idle state can become arbitrarily small, which is ultimately limited by sleep power consumption.

At instant 810 the tag manager receives a multiple-target command, and shortly after starts transmission. Firstly, blocks “T1” represent that the manager transmits a sequence of wireless data (“packet”) as shown in 808 comprising a preamble, a manager ID unique to the present tag manager in order to allow thermostats and sensor tags to distinguish from transmissions by other tag managers with which they are not associated, a command ID with a flag indicating multiple target command, a target thermostat or sensor tag ID (1 in blocks named “T1”, 2 in blocks named “T2”, and 3 in blocks named “T3”), and target ID range information (minimum ID is 1, maximum ID is 3). As shown in FIG. 8, the tag manager cycles through each target ID, but sends out the target ID range information in every packet. No response will be received by the tag manager until activity 805 when Thermostat A is scheduled to wake up from sleep. During activity 805, Thermostat A first receives a transmission from a block “T1”. Its target ID does not match with Thermostat A′s ID, but Thermostat A′s ID falls within the target range. Therefore, step 718 is executed and X is increased. Soon a transmission from block “T2” with a matching target ID is received, and Thermostat A transmits a response in step 608. As a coincidence, (in activity 806) Thermostat B wakes up shortly after Thermostat A wakes up, and receives transmission from the same block “T2”. If the tag manager were to simply include all target IDs in a multi-target command, Both Thermostat B and Thermostat A would have transmitted a response in step 708 at exactly the same time. This would have caused interference on the air and no valid response would be received by the tag manager. Instead, the present invention provides the tag manager to cycle through each target ID as shown in FIG. 8. This method effectively avoids any such possible collision or interference, so response from each thermostat and tag can be received in an orderly manner. At instant 811, the command timeout (Z seconds in step 610) occurs, and the tag manager stops transmission. The timeout is necessary not only to allow tag manager to resume listening for events from other sensor tags, but also to satisfy FCC rules on maximum duration of continuous transmission in the 433 MHz band by unlicensed users.

FIG. 9 depicts a preferred control flow chart used by the embodiment of a sensor tag shown in FIG. 2 and FIG. 3, with more details for steps 712, 713 and 714. Steps 902, 903, 904 corresponds to steps 701 to 709 and 717. After powering off transceiver 204 or 304 in step 904 (or 717), in step 906 the control circuit 203 or 303 decrements a logging interval counter. In the following step 907, it determines if the interval counter has reached 0. If true, in step 908 it resets the logging interval counter to a value configured by the user previously. In the following step 909, it powers on the temperature sensor 207 or 307, takes a measurement of local temperature and/or humidity at the sensor tag, and powers off the sensor 207 or 307 immediately after the measurement. In the following step 910, if logging is enabled previously by tag manager command received in step 903, moves to step 912. If not, the last measured temperature and/or humidity is compared against an upper and lower threshold previously configured by tag manager command received in step 903, in order to determine if a current temperature or humidity zone, namely, too low, normal, or too high. If the current zone changes caused by temperature crossing either threshold, moves to step 912.

In step 912 a retry counter is reset to a value configured by user in preparation for transmission of the updated measurement results. In the next step 921, transceiver 204 or 304 is activated, and in step 920, a packet comprising the preamble, a tag manager ID with which the sensor tag is associated, the ID of the present sensor tag, an event type indicating if the packet contains updated temperature/RH sensor 207 or 307 reading, infra-red sensor 305 or magnetic sensor 205 reading, and the actual reading data are transmitted. Immediately in step 919, the transceiver 204 or 304 is put in receive mode and try to receive a valid response from the tag manager comprising a correct preamble and matching manager ID, or until a timeout. After step 919, the transceiver 204 or 304 may be deactivated in step 918 to conserve battery. If in step 917 no valid response is received, control circuit 203 or 303 determines in step 915 if the retry counter has reached 0. If it has not reached 0, in step 914 the retry counter is decremented. In the following step 913 the control circuit 203 or 303 waits for a small amount of time which may be user configurable. If the wireless communication in step 920 or 919 failed because of temporary interference, then after the wait in step 913, the interference is likely to have gone away. If the retry counter has reached 0, in step 916 the sensor tag disables logging, magnetic or infra-red sensors, as well as temperature/RH sensor. At this stage, it is highly likely that either the tag manager has been powered off, or the tag has been moved completely out of range from the tag manager. By disabling all sensors and logging, likely futile future transmission and repeated re-transmission of sensor events is avoided to conserve battery power. At this step 916, the sensor tag may optionally emit a sound indicating to the user that it has disabled itself because of lost link with the tag manager. Same steps as 912-921 may be taken after step 720 by Thermostat 400 to enter into a local manual mode to allow user to turn on/off heat/AC without command from the tag manager.

FIG. 10 shows a table illustrating examples of custom algorithms and the way each one can be specified by users from 108, 109, 110, and 111. The specified user algorithms are preferably received by Web server 105 and preferably stored in database 120. In example 1001, the user specifies to have the heat/AC automatically turned off when any one of the windows and doors named “window1”, “window2” or “door1” is opened. The script engine 121 executes the user program and assigns the user's specified event handler to each of the sensor tag's open event. When a sensor detects opening, its tag manager uploads its information to web server 105 which in turn updates the database 120. Database change notifications are sent to script engine 121 as a result, and the script engine executes the assigned event handler. In the event handler, a turnOff command to a Thermostat 400 named “thermostat1” is sent through Chat server 104 and eventually to a tag manager and wirelessly to the Thermostat.

In example 1002, the user specifies to resume heat/AC automatically when all of the windows and doors named “window1”, “window2” or “door1” are closed. When any of the sensor tag sends “closed” event, the user program checks to see if every sensor's state is closed, and then restore thermostat1's state before the turnOff command.

In example 1003, the user achieves the goal to turn on AC/heat only when presence is detected by any of the infra-red motion sensor named “room1”, “room2” and “room3”. The user program registers event handler for “detected” and “notDetected” event for each of the three infra-red sensors. In “notDetected” event handler, the algorithm checks if none of the motion sensor is in “detected” state, and then turns off “thermostat1”. In “detected” event handler, “thermostat1” state is restored.

Each thermostat exposes a property “target” to be read and set from user's program. Upon temperature too low, too high, or returned to normal zone event from the target sensor tag, a command to turn on heat, turn on AC, or turn off heat and AC, respectively, is sent to the thermostat. In example 1004, the user achieves the goal to regulate the temperature of the room with occupant. The user does this by writing an event handler that is executed upon a motion “detected” event from each of the three infra-red+temperature sensor tags named “room1”, “room2” and “room3”. The event handler sets the “target” property of the thermostat inside his or her house to the infra-red+temperature sensor tag that detected motion.

In a conventional thermostat, there is only one temperature sensor and it is placed inside the thermostat. Therefore the thermostat can only regulate temperature at the thermostat, which is typically installed in the hall way or downstairs. Temperature in upstairs bedroom may well be different from where the thermostat is installed because the bedroom may be closer to vent or receive more sunshine. The present invention allows a temperature sensor selected from multiple sensor tags to control a thermostat, and to automatically choose which temperature sensor to control the thermostat based on sensed presence information. For example, when the user goes to upstairs bedroom, the temperature at the bedroom is automatically regulated to the user specified comfort zone.

In example 1005, the user installs two temperature sensors named “outside” and “inside” outside of the house and inside, respectively. The user algorithm achieves energy savings by turning off heat/AC and opening the vent automatically when the outside temperature is within specified comfort zone, and restore the heat/AC when outside temperature is too low or too high.

The present invention provides a flexible user interface in the form of script language access for the users to specify customized algorithms to optimize energy usage and comfort, as disclosed in FIG. 10. Alternatively, the system may also present user with a menu/recipe consisting of multiple pre-written scripts such as those shown in FIG. 10, to help new users quickly set-up the automation to suit his or her needs. The user may choose to install one or more pre-written algorithms from the menu/recipe thereof. When the user choose to install an algorithm, the user may manually or ask the system to automatically swap the names of the sensor tags and thermostats in the pre-written script with the names appearing in his/her own setup.

FIG. 11 depicts a preferred control flow chart used by the embodiment of a tag manager shown in FIG. 5, illustrating in more detail the initial start-up sequence and the interaction among the tag manager, the Web Server and the Chat Server. Steps 1120, 1121 and 1122 are executed by the Web server while the rest of the steps are executed by the tag manager. In step 1101, the tag manager 500 is first powered up by the user by plugging in power cable or by a hardware reset. The tag manager in step 1102 acquires a new IP address from the network using DHCP, but other types of IP address configuration schemes or static IP address stored in firmware may also be employed in step 1102. In the following step 1103, the tag manager calls a Login web service method provided by the Web Server 105. In step 1104, the tag manager receives from Web server 105, as return results of the Login web service method, information about the Chat Server 104 including IP address and port number, and a unique nickname for the present tag manager to use when connecting to the Chat Server 104. In step 1120 which is triggered by step 1103, the Web server stores the nickname and Chat Server information in a database to be used later for issuing commands to the tag manager as chat messages through the Chat Server. After step 1104, the tag manager tries to connect to Chat Server 104 by using the information received. If connection is not successful in step 1106, the tag manager may call the same Login web service method or other web service method on the Web server 105 depending on the type of error it received while connecting to the Chat Server. For example, if there was a nickname conflict, the Web Server generates a new nickname and returns to the tag manager. The tag manager then retries connection to the Chat Server in step 1105. If connection to Chat Server is successful, in step 1107 the tag manager waits for a chat message. Step 1107 corresponds to step 601, and step 1108 abbreviates step 602 to 611. If in step 1109 a PING is received from Chat Server 104, in step 1111 the tag manager calls a Ping web service method provided by the Web Server 105. Triggered by step 1111, in step 1122 the Web Server stores the time at which the Ping web method is called for the present tag manager, and compares it with the last time the Ping web method was called for that tag manager. If too much time has passed, step 1121 is triggered. Step 1121 is also triggered shortly after step 1120. In step 1121, it is assumed that the present tag manager has been out of service (power is lost, Internet connection has lost etc.) and has just returned to service. This means while the tag manager has been out of service, some sensor tags may have disabled themselves in step 916. Whether each sensor tag has its magnetic sensor or infra-red sensor enabled, and whether each sensor tag has been enabled to log temperature/RH have been stored in the database 120 accessed by the Web Server 105. The Web Server 105 records all these information about every sensor tag as every user action and configuration command goes through Web Server 105. Using these information, in step 1121 the Web Server issues a series of commands to the tag manager to restore each Tag's states according to the database. For details refer to US Patent Application Publication No. 20130181839. Finally in step 1110, in the event when the TCP/IP connection to the Chat Server 104 is lost, control flow is redirected to step 1103, such that the Web server can direct the tag manager to connect to another Chat Server that is available. By a “soft-reset” configuration command issued by Web server 105 to the tag manager, the control flow may also be redirected to step 1103, such that any particular tag manager may be redirected to a different Chat Server for system maintenance reasons. These methods allow the system in the present invention to maximize availability and robustness against temporary failure of parts of the system.

FIG. 11 shows a table summarizing operation performed by the Web Server 105. A Web server is an event driven system which performs certain actions on certain events, including receiving a web service method call from a client, and timer time-out. When clients 108, 109, 110, and 111 operated by end user interact with the system show in FIG. 1 in the present invention, it is in the form of a web service method call to Web Server 105. Triggered by such events 1201, the Web server 105 translates each user command and sends it to the bi-directional Chat Server. Server 105 waits for a tag manager response from the Chat Server if one is expected for that particular type of command. Server 105 updates database with new tag states and returns updated tag states or various error messages to the clients. The server may also trigger a tag-state-updated event so every client subscribing to events associated with the present tag manager gets updated.

Each tag manager 101 also calls web service methods on Web Server 105. The events 1202, 1203, 1204, and 1205 happen when a tag manager receives a Tag event through transceiver 204, 304 or 404 and calls the Web server in step 613. In 1202, the Tag event is for updated magnetic sensor 205 reading, and the Web server handles this by calculating if door should be deemed open if the sensor tag is configured in a door mode. In 1203, the Tag event is for Hall sensor 205 detecting door/window opened or closed. In 1204, the Tag event is for infra-red sensor 305 detecting motion or a timeout event without detecting motion. In 1205, the Tag event is for temperature or humidity sensor 207, 307, and 407 detecting temperature crossing upper or lower thresholds. The Web Server 105 updates the database 120 to store the event, sensor reading, date and time or other information. As the result, a script engine event may be triggered to execute user algorithms. As configured by user, the Web Server 105 may also send emails, SMS or phone calls (preferably by calling web services on servers 107), and/or mobile notifications (preferably by calling web services on servers 112 or 106), to notify users. In 1206, the event is sent from a Thermostat triggered by physical button press at the Thermostat. The Web server may turn on or off heat/AC and adjust upper and lower threshold at the target temperature sensor tag according to FIG. 13, or alternatively executes user custom algorithm if configured. In 1207, the Tag event is keep-alive “ping”, and the Web server handles this by updating a “last Ping time” for that Tag in database 120.

A timer keeps running at the Web Server and fires event 1208 every 3 seconds or at a similarly short interval. On this event 1208, the Web Server queries the database to find those Tags with “last Ping time” too old taking into account their post-back interval setting in database 120, then sets an out-of-range flag in database 120, and then sends notifications (email, SMS, mobile notifications, phone calls) as configured by user. Another timer keeps running at the Web server and fires event 1209 every 10 minutes or at an interval in the same order. On this event 1209, for each Tag with out-of-range flag set in the database 120, the Web server send a “configure post-back interval” command, in case that the Tag has returned within range. If a response is received, and database shows the Tag is in enabled state, the Web Server also re-sends an “enable sensors” command since the tag may have disabled itself during the time when the wireless link was lost.

Actions to handle event 1210 are as described in step 1121 in association with FIG. 11. The tag manager may periodically call a “Ping” web service method on the Web Server 105. On this event 1211, the Web Server may record current time as “lastPing” for each tag manager in the database 120. This information may be used to quickly determine whether each tag manager is currently available or not, without actually trying sending a command to each tag manager. For example, if it is known that each tag manager will call the Ping web service method every 5 minutes, a database query to find all those tag managers with lastPing older than 5 minutes would return a list of tag managers that may be currently unavailable.

FIG. 13 illustrates a preferred function of the two physical up and down buttons 409 on the Thermostat in FIG. 4. Conventional thermostat typically has buttons to increment and decrement target temperature, and a switch that chooses between heat, AC or off. When the user intends to turn on heat or AC because feeling too cold or too hot, depending on the last set target temperature at the conventional thermostat and current temperature, the user needs to press the increment or decrement button many times. The present invention provides a scheme to allow user to turn on heat/AC with a single button press to reduce user frustration. The scheme also eliminates the need for separate heat, AC or off switch to simplify the thermostat exterior design and reduce manufacturing cost.

I claim:

1. A system for allowing users to automatically turn on or off heat or air conditioning based on events from a sensor tag comprising, at least one tag manager, at least one sensor tag, at least one thermostat, at least one Internet service, and at least one mobile device, wherein said tag manager is wirelessly coupled to each one of said sensor tag and thermostat, and said tag manager being capable of connecting to the Internet service, wherein said tag manager comprising:
a first control circuit;
a first wireless transceiver circuit coupled to said first control circuit for initiating wireless transmission to and receiving response from each one of said sensor tags;
a means to receive wireless transmission from each one of said sensor tags; and
said sensor tag comprising:
a second control circuit;
a second wireless transceiver circuit coupled to said second control circuit for sending and receiving wireless transmission to and from said tag manager;
a first sensor device for measuring temperature;
a second sensor device for detecting movement;
a means to transmit readings of said first and second sensor device to said tag manager;
and a means for timing control coupled to said second control circuit for periodically activating for a short period of time and then de-activating said wireless signal transceiver circuit and said sensor devices, thereby significantly reducing average power consumption of said sensor tag to allow a long battery life; and
said thermostat comprising:
at least one electronic relay for turning on or off HVAC functions;
a third control circuit;
a third wireless transceiver circuit coupled to said third control circuit for sending and receiving wireless transmission to and from said tag manager;
a means to transmit readings of said third sensor device to said tag manager;
and a means for timing control coupled to said third control circuit for periodically activating for a short period of time and then de-activating said wireless signal transceiver circuit and said sensor device, thereby significantly reducing average power consumption of said sensor tag to allow a long battery life;
said Internet service comprising:
a bi-directional chat server for passing commands to said tag manager in real time, a database for storing information received from said tag manager, said sensor tag and said thermostat;
a script engine coupled to said database and said chat server for generating commands based on changes of information stored in said database; and
said mobile device comprising:
a program for specifying algorithms on said script engine through the Internet, comprising one selected from the group consisting of a web browser and a native custom application; and
a program for receiving real time notifications.

2. The system of claim 1, wherein said script engine further comprises a means to issue commands to turn on or off said thermostat based on the readings of said second temperature sensor device.

3. The system of claim 1, wherein said script engine further comprises a means to issue commands to turn on or off said thermostat based on the motion event of said first motion detection sensor device.

4. The system of claim 1, further comprising a second sensor tag identical to the first sensor tag; and said script engine further comprises a means to choose if the temperature reading from the first or second sensor tag should be used to control said thermostat, based on when, and if, the motion detection sensor device on said first or on said second sensor tag detected movement.

5. The system of claim 1, further comprising a second sensor tag identical to the first sensor tag; and said script engine further comprises a means to turn on or off thermostat based on the difference of temperature readings between the temperature sensor devices on the first and that on the second sensor tag.

6. A method for allowing users to set temperature and to turn on heating and cooling HVAC functions with a single button press from a thermostat device by using only an up and a down button, comprising the steps of:
when the up button is pressed, if heating and cooling is currently off, setting an internal lower temperature threshold to a fixed amount above the current temperature, thereby turning on heating HVAC function with a single button press, and setting an internal upper temperature threshold to a fixed amount above the lower temperature threshold;
when the down button, if heating and cooling is currently off, setting the internal upper temperature threshold to a fixed amount below the current temperature, thereby turning on cooling HVAC function with a single button press, and setting the internal lower temperature threshold to a fixed amount below the upper temperature threshold;
when the up button is pressed, if current state is cooling, raising both the upper and lower temperature threshold by a fixed amount;
when the down button is pressed, if current state is heating, lowering both the upper and lower temperature threshold by a fixed amount;
turning on the heating HVAC function if the lower temperature threshold is higher than the current temperature;
turning on the cooling HVAC function if the upper temperature threshold is lower than the current temperature;
turning off the heating HVAC function if the lower temperature threshold is lower than the current temperature; and
turning off the cooling HVAC function if the upper temperature threshold is higher than the current temperature.
